(19) United States
(12) Patent Application Publication
(10) Pub. No.: US 2017/0226992 A1
(43) Pub. Date: Aug. 10, 2017

(54) Geothermal Power Plant

(71) Applicant: ORMAT Technologies, Inc., Reno, NV (US)

(72) Inventor: Dany BATSCHA, Kiriat Ono (IL)

(21) Appl. No.: 15/040,491

(22) Filed: Feb. 10, 2016

(51) Int. Cl. F03G 7/04; F01K 9/00; F01K 7/16

(52) U.S. Cl. CPC F03G 7/04; F01K 7/16; F01K 9/003

(57) ABSTRACT

The present invention provides a power plant whose motive fluid is geothermal fluid, comprising: a high-pressure steam turbine to which geothermal fluid is supplied to produce power; a high-pressure condenser to which the geothermal fluid exhausted from the high-pressure turbine after being expanded therein is supplied and condensed, said high-pressure condenser being configured with a port through which non-condensable gases contained in the geothermal fluid supplied to the high-pressure turbine are extractable in an extraction process and further configured to use heat being released during condensation of the high-pressure steam turbine exhaust to vaporize the steam condensate produced therein for producing low pressure steam without non-condensable gases; and a low-pressure steam turbine for producing power from said low-pressure steam without non-condensable gases supplied from said high-pressure condenser.

### FIELD

The present invention relates to the field of geothermal energy. More particularly, the invention relates to apparatus for increasing the power level of a geothermal power plant.

### BACKGROUND

Two-phase geothermal fluid has been shown to be a convenient and readily available source for power production in many areas of the world. The use of a steam turbine is a well-accepted method for exploiting the energy content of geothermal steam. Furthermore, the use of an Organic Rankine Cycle (ORC) has been made for producing additional power from low pressure steam exiting a geothermal steam turbine. An Organic Rankine Cycle (ORC) has also been previously used to produce power from geothermal liquid or brine separated from geothermal steam. Organic fluid flowing in a closed binary cycle vaporizes after extracting heat from the geothermal fluid to expand and produce power in an organic vapor turbine.

The presence of non-condensable gases (NCGs), such as carbon dioxide and hydrogen sulfide, in the geothermal steam also reduces the profitability of the power plant. Since the NCGs do not condense, they tend to increase the pressure in the condenser to which the steam turbine exhaust is discharged. If the NCGs are not extracted from the condenser, the heat transfer efficiency of the condenser will be reduced and the ability for the geothermal fluid to expand in the steam turbine can be impaired.

Several methods for extracting the NCGs from the condenser are known. One typical gas extraction system comprises a centrifugal compressor; however, installation and operation costs are relatively high. Another extraction method involves a steam ejector by which a high-velocity jet of steam is discharged across a suction chamber in fluid communication with the condenser to induce entrainment of the NCGs. The main disadvantage of the use of a steam ejector is the large consumption of high-pressure steam that may be supplied from the steam turbine input line and that cause a substantial reduction in power output.

U.S. Pat. No. 6,912,853 discloses a geothermal steam power plant comprising a high-pressure separator for supplying high-pressure geothermal steam to a high-pressure steam turbine, as well as brine to a low-pressure separator. Low-pressure steam is produced by the low-pressure separator and is supplied to a low-pressure steam turbine. No utilization of the steam turbine exhaust is described in this U.S. patent mentioned above.

It is an object of the present invention to provide a geothermal power plant of increased power output.

It is an additional object of the present invention to provide a geothermal power plant that does not utilize an ORC power plant.

Other objects and advantages of the invention will become apparent as the description proceeds.

### SUMMARY

The present invention provides a power plant whose motive fluid is geothermal fluid, comprising: a high-pressure steam turbine to which geothermal fluid is supplied to produce power; a high-pressure condenser to which the geothermal fluid exhausted from the high-pressure turbine after being expanded therein is supplied and condensed, said high-pressure condenser being configured with a port through which non-condensable gases contained in the geothermal fluid supplied to the high-pressure turbine are extractable in an extraction process and further configured use heat being released during condensation of the high-pressure steam turbine exhaust to vaporize the steam condensate produced therein for producing low-pressure steam without non-condensable gases; and a low-pressure steam turbine for producing power from said low-pressure steam without non-condensable gases supplied from said high-pressure condenser.

Advantages of this power plant include more efficient NCG extraction by maintaining the high-pressure steam turbine exhaust at a pressure higher than atmospheric pressure, increased power output by supplying the same geothermal fluid through more than one steam turbine and without diverting any of the high-pressure steam to a steam ejector, and increasing the value of the power plant.

The present invention is also directed to a self-condensing condenser-vaporizer unit (CVU), comprising a shell defining a CVU interior; a shell inlet in communication with said CVU interior into which a motive fluid to be condensed is introduced; a plurality of tubes for contacting and condensing said motive fluid as it flows within said CVU interior and across said plurality of tubes; a surface onto which said motive fluid collects after condensing; a shell outlet coinciding with a portion of said surface, through which the condensed motive fluid or steam condensate is discharged; and a recirculation conduit extending from said shell outlet to an inlet of said plurality of tubes through which said steam condensate is delivered.

### BRIEF DESCRIPTION OF THE DRAWINGS

In the drawings:

FIG. 1 is a schematic illustration of a geothermal power plant, according to one embodiment of the present invention; and

FIG. 2 is a perspective, partial cutaway view of an embodiment of a condenser-vaporizer unit used in conjunction with the power plant of FIG. 1.

### DETAILED DESCRIPTION

The novel geothermal power plant of the present invention increases power plant efficiency and power output by being powered solely by geothermal resources and by use of a self-condensing condenser-vaporizer unit (CVU).

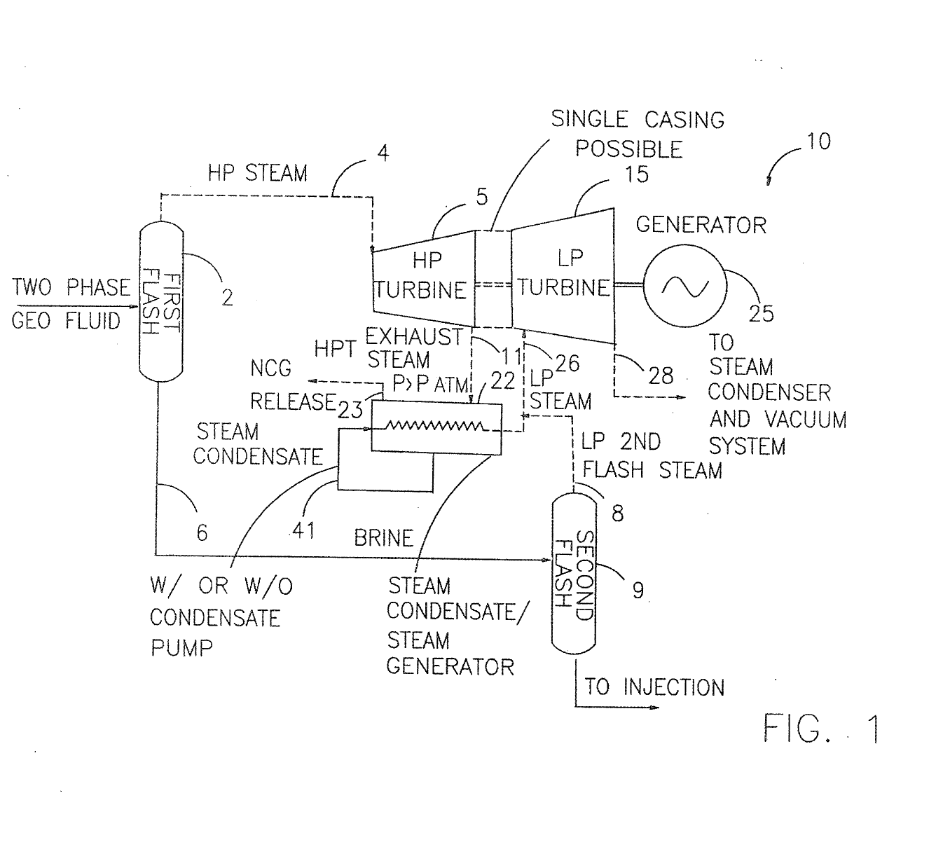

FIG. 1 schematically illustrates the geothermal power plant of the present invention, generally designated by numeral 10. Geothermal power plant 10 comprises high-pressure steam turbine 5 and low-pressure steam turbine 15, which are coupled to generator 25 and may be housed in a single casing. It is in the scope of the invention that each turbine may be coupled to a different generator.

A two-phase geothermal resource having a relatively high level of NCGs, e.g. greater than about 5%, is extracted from a production well and supplied to first flash steam separator 2. A pressure drop may be induced in the geothermal fluid, causing the geothermal fluid to be separated into a first high-pressure steam phase portion delivered via conduit 4 to high-pressure steam turbine 5, and into a second liquid phase portion, e.g. brine, delivered via conduit 6 to second flash steam separator 8.

The high-pressure steam is expanded in high-pressure steam turbine 5 to produce power, and is then exhausted, at a pressure above atmospheric pressure, via conduit 11 to CVU 22. The low-pressure steam produced and exiting CVU 22 flows thereafter via conduit 28 to low-pressure steam turbine 15 at a pressure higher than atmospheric pressure in order to also produce power. Optionally, an additional amount of low-pressure steam, produced in second flash steam separator 8 from the separated liquid phase portion flowing in conduit 6 using a pressure drop, can also be supplied to low-pressure turbine 15 via conduit 9, which is connected to conduit 26 so that the addition low-pressure steam can be combined with the low pressure steam exiting CVU 22. The liquid discharged from such a second flash steam generator 8 can be re-injected into an injection well in order to replenish the geothermal resource. Advantageously, as an option, an ORG power system can be used to extract heat and produce power from the liquid discharged from such a second flash steam generator 8 prior to being re-injected into the injection well.

High-pressure steam turbine 5 is a back-pressure steam turbine configured such that the pressure of the heat depleted geothermal steam exhausted therefrom is greater than atmospheric pressure. This facilitates the extraction of the NCGs from CVU 22 via port 23 formed in its casing, which can be extracted, for example, by a vent thus reducing operating costs of power plant 10 and increasing the total power output of the plant. By virtue of the NCG extraction, the blades of low-pressure turbine 15 need not be made of a corrosion resistant material to ensure turbine longevity. Furthermore, the possibility of the presence of moisture in the low-pressure turbine is reduced. The extracted NCGs may be reinjected into the ground, or alternatively vented to the atmosphere.

The novel configuration of power plant 10 thus exploits the energy content of the geothermal resource by introducing the same geothermal fluid through more than one steam turbine to produce an increased amount of power, without relying on a binary cycle such as an ORC to power the bottoming turbine. NCG extraction independently of a steam ejector helps to maximize power output. The use of a steam ejector in the prior art, in contrast, usually necessitates diversion of some of the steam delivered to the high-pressure steam turbine to induce entrainment of the NCGs, thereby reducing the inlet pressure or steam flow supplied to the steam turbine and the power output of the plant.

The low-pressure steam expanded in low-pressure turbine 15 is exhausted via conduit 28 and supplied to a condenser and a vacuum system. The vacuum system maintains the condensate at sub-atmospheric pressure conditions, to achieve a large pressure differential between the inlet pressure of high-pressure steam turbine 5 and the outlet pressure from low-pressure steam turbine 15, thereby providing correspondingly high thermal efficiency levels and effective power production.

For example, the inlet pressure of the high-pressure steam at the high-pressure turbine may be about 8 bara and the outlet pressure from the high-pressure turbine may be about 1.25 bara, allowing the high-pressure turbine to produce about 10.4 MW. The low-pressure turbine can produce about 19.15 MW.

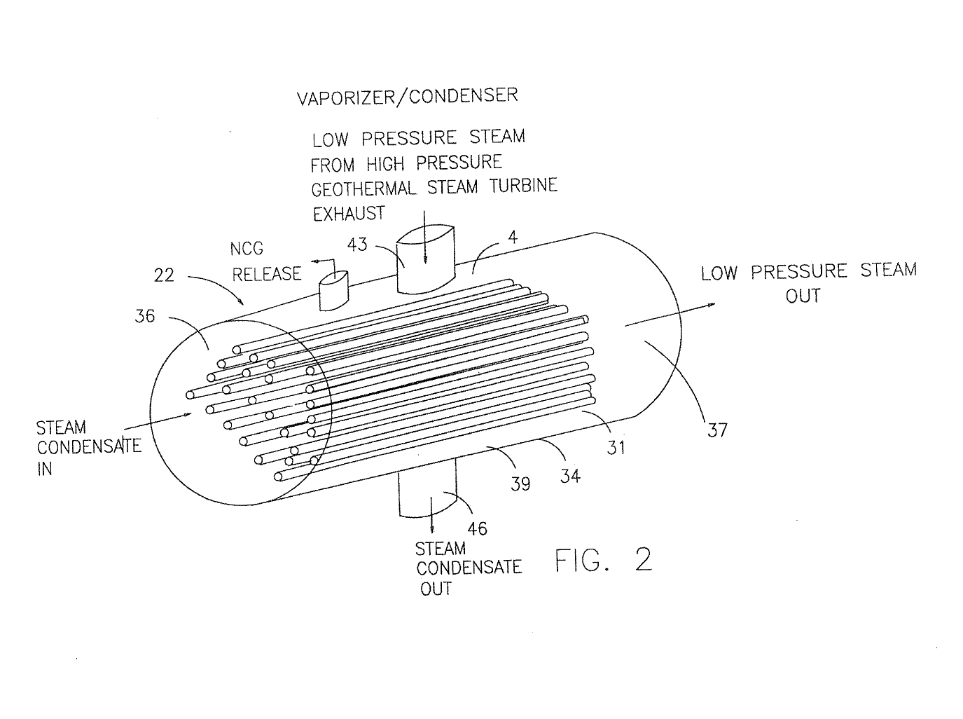

With reference also to FIG. 2, the configuration and operation of CVU 22 will now be described. CVU 22 comprises a plurality of tubes 31 that advantageously extend axiaily in a same direction, generally horizontally disposed, from ingress tubesheet 36 to egress tubesheet 37. Tubesheets 38 and 37 are fitted in opposed axial ends of CVU shell 34, namely tubesheets, and are formed with apertures within which each corresponding tube 31 is inserted, to ensure that each tube will be suitably fed with condensate. The number of tubes, size of tubes, spacing between adjacent tubes are selected to optimize condensation of the high-pressure steam turbine exhaust.

A recirculation conduit 41 extends from condenser hotwell 39, into which the high-pressure steam turbine exhaust collects after condensing as steam condensate, to ingress 36. A condensate pump may be operatively connected to recirculation conduit 41 in order to feed the steam condensate by a sufficiently high flowrate through the tubes 31 for ensuring evaporation of the steam condensate and condensation of the high-pressure steam turbine exhaust.

Accordingly, the high-pressure turbine exhaust, after being introduced to CVU 22 via an upper inlet 43 fitted in shell 34, flows downwardly towards the plurality of tubes 31 and collects within hotwell 39 in the form of liquid steam condensate at the bottom of shell 34. As hotwell 39 is sloped, the collected condensate is directed to lower outlet 46 and then into recirculation, conduit 41, to be fed into the various tubes 31 in order to condense additional high-pressure turbine exhaust. During the downward flow of the high-pressure turbine exhaust across tubes 31, the exhaust steam condenses as heat is extracted therefrom and absorbed by the steam condensate flowing through each of the tubes such that steam condensate is produced.

Due to the condensation of the steam, the NCGs will separate out so that the NCGs can be consequently extracted from CVU 22 via port 23.

During startup of the power plant prior to the generation of steam condensate within CVU 22, a water tank may be used to supply an adequate flow of water to initiate the process of condensing the high-pressure steam turbine exhaust until sufficient liquid steam condensate is produced to continue on the condensing process. A conduit means extending from the water tank can be connected to the tubes 31 port of CVU shell 34 in order that the water tank be in fluid communication with tubes 31.

As the high-pressure steam turbine exhaust condenses, the liquid steam condensate flowing through the plurality of tubes 31 is vaporized by means of the heat released from the condensing exhaust. The so generated low-pressure steam exits CVU 22 via egress tubesheet 37 to conduit 26 without NCGs and can be combined with the discharge from second flash steam generator 8 for supply to low-pressure steam turbine 15 so that power is generated thereby.

As can be appreciated, the self-condensing CVU 22 by which the condensate is resupplied thereto advantageously effects condensation of additional turbine exhaust without an additional cooling medium.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A power plant whose motive fluid is geothermal fluid, comprising:
a. a high-pressure steam turbine to which geothermal fluid is supplied to produce power;
b. a high-pressure condenser to which the geothermal fluid exhausted from the high-pressure turbine after being expanded therein is supplied and condensed, said high-pressure condenser being configured with a port through which non-condensable gases contained in the geothermal fluid supplied to the high-pressure turbine are extractable in an extraction process and further configured to use heat being released during condensation of the high-pressure steam turbine exhaust to vaporize the steam condensate produced therein for producing low-pressure steam without non-condensable gases; and
c. a low-pressure steam turbine for producing power from said low-pressure steam without non-condensable gases supplied from said high-pressure condenser.

2. The power plant according to claim 1, wherein the geothermal fluid that is supplied to the low-pressure steam turbine is at a pressure higher than atmospheric pressure.

3. The power plant according to claim 1, wherein the high-pressure condenser is a self-condensing condenser-vaporizer unit (CVU).

4. The power plant according to claim 3, wherein the CVU comprises:
a) a plurality of tubes for contacting and condensing the high-pressure steam turbine exhaust as it flows across said plurality of tubes within a CVU interior;
b) a condenser hotwell into which the high-pressure steam turbine exhaust collects after condensing as steam condensate; and
c) a recirculation conduit extending from said condenser hotwell to an inlet of said plurality of tubes through which said steam condensate is delivered.

5. The power plant according to claim 4, wherein the steam condensate flowing through the plurality of tubes is vaporized in response to heat being released during condensation of the high-pressure steam turbine exhaust and exits the CVU as low-pressure steam that is supplied to the low-pressure steam turbine via a low-pressure steam turbine inlet conduit.

6. The power plant according to claim 5, wherein the inlet of the tubes coincides with an ingress tubesheet fitted at a first axial end of a shell of the CVU, and an outlet of the tubes coincides with an egress tubesheet fitted at a second axial end of said shell and in fluid communication with the low-pressure steam turbine inlet conduit.

7. The power plant according to claim 5, wherein the geothermal fluid supplied to the high-pressure steam turbine comprises a high-pressure steam phase portion which has been separated from said geothermal fluid supplied from a two-phase geothermal resource via a production well.

8. The power plant according to claim 7, further comprising a first flash separator by which the two-phase geothermal fluid is separated into the high-pressure steam phase portion and a liquid phase portion, and a second flash separator to which said liquid phase portion is delivered, wherein an additional amount of low-pressure steam exiting said second flash separator is combined with low-pressure steam flowing in said low-pressure steam turbine inlet conduit.

9. The power plant according to claim 4, further comprising a water tank for supplying cooling water to initiate condensation of the high-pressure steam turbine exhaust during startup of the power plant, and a conduit means extending from said water tank to a port of a shell of the CVU shell which is in fluid communication with the inlet of the tubes.

10. The power plant according to claim 4, further comprising a steam condensate pump operatively connected to the recirculation conduit for feeding the steam condensate at a sufficiently high flowrate through the plurality of tubes to ensure condensation of the high-pressure steam turbine exhaust.

11. A self-condensing condenser-vaporizer unit (CVU), comprising;
a) a shell defining a CVU interior;
b) a shell inlet in communication with said CVU interior into which a motive fluid to be condensed is introduced;
c) a plurality of tubes for contacting and condensing said motive fluid as it flows within said CVU interior and across said plurality of tubes;
d) a surface onto which steam condensate produced collects after condensing;
e) a shell outlet coinciding with a portion of said surface, through which said condensed motive fluid or steam condensate is discharged; and
f) a recirculation conduit extending from said shell outlet to an inlet of said plurality of tubes through which said steam condensate is delivered.
